(19) United States
(12) Patent Application Publication
(10) Pub. No.: US 2026/0268712 A1
(43) Pub. Date: Sep. 10, 2026

(54) OBJECT DETECTION METHOD, ELECTRONIC DEVICE, COMPUTER-READABLE STORAGE MEDIUM

(71) Applicant: MASHANG CONSUMER FINANCE CO., LTD., Chongqing (CN)

(72) Inventor: Yue FENG, Chongqing (CN)

(21) Appl. No.: 19/296,138

(22) Filed: Aug. 11, 2025

(30) Foreign Application Priority Data
Mar. 6, 2025 (CN) 202510264941.4

(51) Int. Cl. G06V 40/40; G06T 7/246; G06T 7/73; G06V 10/74; G06V 20/40; G06V 40/16; G06V 40/60

(52) U.S. Cl. CPC G06V 40/45; G06T 7/248; G06T 7/74; G06V 10/761; G06V 20/46; G06V 40/165; G06V 40/67; G06T 2207/10016; G06T 2207/30201

(57) ABSTRACT

An object detection method, an electronic device, a computer-readable storage medium, are provided. The method includes: determining, in response to a first detection request for a first object, first position data of a key part of the first object at each moment and second position data of a detection device at each moment while the detection device detects the first object; determining first action data of the first object at each moment based on the first position data, and determining second action data of the detection device at each moment based on the second position data; and determining a similarity between the first action data and the second action data at a same moment, and determining a detection result for the first object based on the similarity.

### CROSS-REFERENCE TO RELATED APPLICATION

This application claims the benefit of priority of Chinese Patent Application No. 202510264941.4, filed on Mar. 6, 2025, the contents of which are incorporated herein by reference in its entirety for all purposes.

### BACKGROUND

Liveness recognition is a biometric recognition technology used to verify the authenticity of personal identity and ensure that an object being verified is a living individual rather than a forged counterfeit, and liveness recognition technology is usually completed by detecting the physiological or behavioral characteristics of the object.

However, at present, in the related art, there are methods of phantom detection or liveness detection in which a user is enabled to complete a corresponding action by sending an action instruction to the user, and these liveness detection methods rely too much on a specific detection environment or user behavior when performing liveness result detection, and are prone to misrecognition, resulting in low accuracy and poor robustness of liveness detection.

### SUMMARY

Embodiments of the present disclosure provide an object detection method and apparatus, an electronic device, a computer-readable storage medium, and a computer program product.

The technical solutions in the embodiments of the present disclosure are implemented as follows:

The embodiments of the present disclosure provide an object detection method, the method including: determining, in response to a first detection request for a first object, first position data of a key part of the first object at each moment and second position data of a detection device at each moment while the detection device detects the first object; determining first action data of the first object at each moment based on the first position data, and determining second action data of the detection device at each moment based on the second position data; and determining a similarity between the first action data and the second action data at a same moment, and determining a detection result for the first object based on the similarity.

An embodiment of the present disclosure provides an electronic device, including: a memory for storing computer-executable instructions or a computer program; and a processor configured to execute the computer-executable instructions or the computer program stored in the memory to perform: determining, in response to a first detection request for a first object, first position data of a key part of the first object at each moment and second position data of a detection device at each moment while the detection device detects the first object; determining first action data of the first object at each moment based on the first position data, and determining second action data of the detection device at each moment based on the second position data; and determining a similarity between the first action data and the second action data at a same moment, and determining a detection result for the first object based on the similarity.

The embodiments of the present disclosure provide a computer-readable storage medium having stored thereon computer-executable instructions or a computer program that when executed by a processor, implement or implements an object detection method, the object detection method including: determining, in response to a first detection request for a first object, first position data of a key part of the first object at each moment and second position data of a detection device at each moment while the detection device detects the first object; determining first action data of the first object at each moment based on the first position data, and determining second action data of the detection device at each moment based on the second position data; and determining a similarity between the first action data and the second action data at a same moment, and determining a detection result for the first object based on the similarity.

### BRIEF DESCRIPTION OF THE DRAWINGS

FIG. 1 is a schematic diagram of a structure of an object detection system architecture provided by an embodiment of the present disclosure;

FIG. 2 is a schematic diagram of a structure of an electronic device provided by an embodiment of the present disclosure;

FIG. 3 is a schematic flowchart of an object detection method provided by an embodiment of the present disclosure;

FIG. 4A is a schematic diagram of displaying a detection box by a detection device provided by an embodiment of the present disclosure;

FIG. 4B is a schematic diagram of a first object moving a detection device provided by an embodiment of the present disclosure;

FIG. 5 is a schematic diagram of a data structure of position data provided by an embodiment of the present disclosure;

FIG. 6A is a schematic diagram of a data structure of first position data provided by an embodiment of the present disclosure;

FIG. 6B is a schematic diagram of a data structure of second position data provided by an embodiment of the present disclosure;

FIG. 7 is a schematic diagram of a display screen of a first object in a detection device provided by an embodiment of the present disclosure;

FIG. 8 is a schematic diagram of an accelerometer and a gyroscope provided by an embodiment of the present disclosure; and

FIG. 9 is a schematic diagram of data alignment provided by an embodiment of the present disclosure.

It should be noted that “first” and “second” above are only used to distinguish different solutions, and do not represent a degree of superiority or inferiority of the solutions, or a priority in the implementation procedure.

### DETAILED DESCRIPTION

To make the objectives, technical solutions, and advantages of the present disclosure clearer, the present disclosure will be described in further detail below with reference to the drawings. The described embodiments should not be regarded as limiting the present disclosure. All other embodiments that are obtained by those of ordinary skill in the art without involving inventive skill fall within the scope of protection of the present disclosure.

When the following description refers to “some embodiments”, said phrasing describes a subset of all possible embodiments, but it can be understood that “some embodiments” may be the same subset or different subsets of all possible embodiments, and may be combined with each other without conflict.

The term “first\second\third” as referred to in the following description is only to distinguish similar objects, and does not represent a specific ordering of objects. It can be understood that the specific order or sequential order of “first\second\third” may be interchanged if allowed, so that the embodiments of the present disclosure described herein can be implemented in an order other than those illustrated or described herein.

In the embodiments of the present disclosure, the term “module” or “unit” refers to a computer program or a part of a computer program that has a predetermined function, works together with other related parts to achieve a predetermined objective, and may be implemented in whole or in part by using software, hardware (such as a processing circuit or a memory), or a combination thereof. Similarly, one processor (or a plurality of processors or memories) may be used to implement one or more modules or units. Furthermore, each module or unit may be a part of an integral module or unit that includes the functionality of the module or unit.

Unless otherwise defined, all technical and scientific terms used in the embodiments of the present disclosure have the same meanings as commonly understood by a person of ordinary skill in the technical field to which the present disclosure belongs. The terms used in the embodiments of the present disclosure are only for the purpose of describing the embodiments of the present disclosure, and are not intended to limit the present disclosure.

In the embodiments of the present disclosure, the relevant data collection processing, when applied to examples, should strictly obtain informed consent or separate consent from the personal information object according to the requirements of relevant laws and regulations, and carry out subsequent data use and processing within the scope of the laws and regulations and the authorization of the personal information object.

Before the embodiments of the present disclosure are further described in detail, the nouns and terms referred to in the embodiments of the present disclosure are illustrated. The nouns and terms referred to in the embodiments of the present disclosure are applicable to the following explanations.

1) “In response to” is used to indicate a condition or state on which an operation to be executed depends. When such condition or state is met, one or a plurality of operations to be executed may be performed in real time or with a set delay. Unless otherwise specified, there is no limitation on the sequence of the plurality of operations to be executed.

Liveness recognition is a biometric recognition technology used to verify the authenticity of a personal identity and ensure that an object being verified is a living individual rather than a forged counterfeit, and liveness recognition technology is usually completed by detecting the physiological or behavioral characteristics of the object, including but not limited to the face, fingerprint, iris, voiceprint, etc., with a form including but not limited to silence, numbers, dynamic colors, actions, and other forms. The key to liveness recognition is its ability to distinguish between liveness and a corpse or replica.

The liveness recognition technology is usually integrated into a client of a service APP as a functional module, and the technology is often used as a means of attack check. For example, a “teenage anti-addiction mode” in a game uses a liveness recognition manner to prevent teenagers from becoming excessively addicted to gaming. For another example, “driver identity verification on duty” in business vehicle management also uses a liveness recognition manner to confirm a manual on-duty request. For still another example, “anti-crawler” in various knowledge websites also uses a liveness recognition manner to perform crawler interception. For yet another example, in the financial industry, a liveness recognition verification manner is usually used to apply for user authorization or monitor and verify a user identity, to prevent attack risks such as rephotographing, rerecording, and injection.

In the related art, the liveness recognition manner includes initiating an action challenge (such as a combined action of blinking, opening the mouth, shaking the head, nodding the head, etc.) to a user. When a user object performs liveness recognition on a certain client, the client may display a fixed face detection box, and the user object places the face in a face detection box and makes a corresponding action according to a prompt, such as opening the mouth, shaking the head left and right, shaking the head up and down, blinking, etc. This manner uses technologies such as face key part positioning, face tracking, and action recognition to verify whether the user is real liveness. The core of this detection manner is to implement a challenge based on randomness of actions, and it is assumed that only living humans can complete related action commands. The implementation process of this manner includes the following: a client sends a random action request to a server, and the server provides a random action command and starts the countdown for an action command declaration period; the client initiates an action prompt to a user according to the random action command, and collects user action data; and the user executes a related action, the client returns a detection video collected for the user to the server for object detection, and the server performs parsing based on a preset detection algorithm and calculates whether the action made by the user is consistent with the random action command. In this way, the user usually needs to complete two rounds of actions for recognition, which takes a long time and results in poor user experience. Moreover, it is easily cracked by injection attacks due to the limited combinations of actions.

In the related art, the liveness recognition manner further includes colorful liveness recognition, which may also be referred to as colorful liveness, light liveness, etc. This manner proposes a liveness recognition algorithm based on light sequence recognition, which initiates a light challenge to the user and uses an algorithm to recognize whether a corresponding light sequence appears on the user's face. In this manner, technologies such as face key part positioning, face tracking, and color recognition are used to verify whether the user is real liveness. The core of colorful liveness recognition is to implement a challenge based on the color and frequency of light changes, and it is assumed that only human faces can specifically feed back the information of these light signals. The process of colorful liveness recognition may include the following: a client sends a random colorful command request to a server; the server provides a random colorful command and starts the countdown for the life cycle of the colorful command; the client initiates a colorful prompt to a user according to the random colorful command and collects user data; the user makes a silent response and waits for the end of a colorful detection collection period; the client returns a collected detection video to the server; and based on a preset detection algorithm, the server detects whether a light signal of the user's face is consistent with the random colorful command. In this way, under the condition of strong light in the daytime, a “colorful” screen of a terminal on which the client is installed cannot effectively reflect colorful light, which results in a poor detection effect and poor robustness of the detection method. Moreover, the high-intensity “colorful” screen will cause discomfort to the eyes of the user, resulting in poor user experience.

The liveness recognition manner in the related art and the process of object detection for the liveness recognition manner both depend on a specific detection environment or user behavior, and misrecognition is likely to occur in the case of a change in the detection environment or a change in the user behavior, resulting in low efficiency and poor robustness of liveness detection.

The embodiments of the present disclosure provide an object detection method and apparatus, an electronic device, a computer-readable storage medium, and a computer program product, which can implement detection in various environments, reduce misrecognition, and improve robustness of liveness detection of objects.

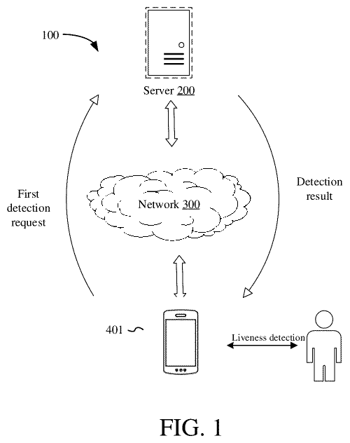

Referring to FIG. 1, FIG. 1 is a schematic diagram of an architecture of the object detection system 100 provided by the embodiments of the present disclosure. In order to support an object detection application, a terminal 401 is connected to a server 200 by means of a network 300. The network 300 may be a wide area network or a local area network, or a combination of the two.

The terminal 401 may be considered as a detection device that detects a first object, and the first object may complete an object detection process in the terminal 401. Specifically, when the terminal 401 needs to detect the first object, the detection process is started. The server 200 generates, in response to a detection start request of the terminal 401, a service identifier of an object detection service and a detection box set based on the device identifier of the terminal 401, and sends the service identifier and the detection box set to the terminal 401. The terminal 401 may render and display a detection box on a graphical interface based on the detection box set until detection of the first object is completed, generate a first detection request for the first object, and send the first detection request to the server 200. The server 200 determines, in response to the first detection request for the first object, first position data of a key part of the first object at each moment and second position data of a detection device (the terminal 401) at each moment when the detection device (the terminal 401) detects the first object; determines first action data of the first object at each moment based on the first position data, and determines second action data of the detection device at each moment based on the second position data; and determines a similarity between the first action data and the second action data at a same moment, and determines a detection result for the first object based on the similarity. The server 200 may actively send the detection result to the terminal 401, to display the detection result to the first object on a graphical interface.

In some embodiments, the terminal 401 may be implemented as various types of terminal, such as a notebook computer, a tablet computer, a desktop computer, a set-top box, a smart phone, a smart speaker, a smart watch, a smart television, or an in-vehicle terminal, or may be implemented as a server.

In some embodiments, the server 200 may be an independent physical server, or may be a server cluster or a distributed system composed of a plurality of physical servers, or may be a cloud server that provides basic cloud computing services such as cloud services, cloud databases, cloud computing, cloud functions, cloud storage, network services, cloud communication, middleware services, domain name services, security services, content delivery networks (CDN) and big data and artificial intelligence platforms. The terminal and the server may be directly or indirectly connected by means of wired or wireless communication means, which is not limited in the embodiments of the present disclosure.

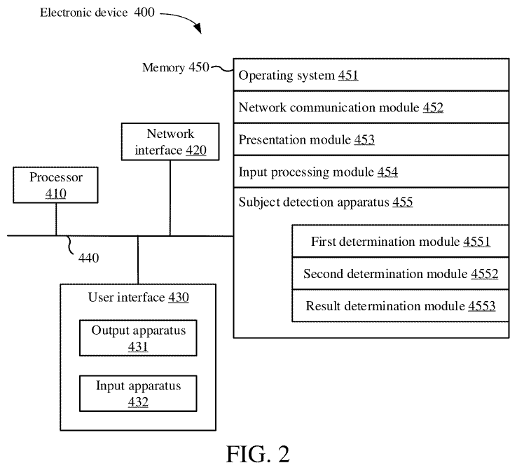

Referring to FIG. 2, FIG. 2 is a schematic diagram of a structure of an electronic device 400 according to an embodiment of the present disclosure. The electronic device 400 shown in FIG. 2 includes: at least one processor 410, a memory 450, at least one network interface 420, and a user interface 430. Various components in the electronic device 400 are coupled together by means of a bus system 440. It may be understood that the bus system 440 is used to implement connection and communication between these components. The bus system 440, in addition to a data bus, includes a power supply bus, a control bus, and a status signal bus. However, for the sake of clear illustration, the various buses are all designated as the bus system 440 in FIG. 2.

The processor 410 may be an integrated circuit chip having signal processing capabilities, such as a general-purpose processor, a digital signal processor (DSP), or another programmable logic device, a discrete gate or transistor logic device, a discrete hardware component, or the like. The general-purpose processor may be a microprocessor, any conventional processor, or the like.

The user interface 430 includes one or more output apparatuses 431 that enable presentation of media content, including one or more speakers and/or one or more visual display screens. The user interface 430 further includes one or more input apparatuses 432, including user interface components that facilitate user input, such as a keyboard, a mouse, a microphone, a touchscreen display screen, a camera, or another input button and control.

The memory 450 may be removable, non-removable, or a combination thereof. An exemplary hardware device includes a solid-state memory, a hard disk drive, an optical-disc drive, or the like. The memory 450 optionally includes one or more memory devices physically located remote from the processor 410.

The memory 450 includes a volatile memory or a non-volatile memory, or may include both a volatile memory and a nonvolatile memory. The non-volatile memory may be a read-only memory (ROM), and the volatile memory may be a random access memory (RAM). The memory 450 described in the embodiments of the present disclosure is intended to include any suitable type of memory.

In some embodiments, the memory 450 can store data to support various operations. Examples of the data include programs, modules and data structures, or a subset or superset thereof, as exemplarily described below.

An operating system 451 includes a system program used to process various basic system services and execute hardware-related tasks, such as a framework layer, a core library layer, and a driver layer, and used to implement various basic services and process hardware-based tasks.

A network communication module 452, which is used to access another electronic device via one or more (wired or wireless) network interfaces 420. An exemplary network interface 420 includes: Bluetooth, wireless compatibility authentication (WiFi), a universal serial bus (USB), and the like.

A presentation module 453, which is used to present information via one or more output apparatuses 431 (for example, a display screen, a speaker, or the like) associated with a user interface 430 (for example, a user interface for operating a peripheral device and displaying content and information).

An input processing module 454, which is used to detect one or more user inputs or interactions from one of the one or more input apparatuses 432, and translate the detected inputs or interactions.

In some embodiments, the apparatus provided by the embodiments of the present disclosure may be implemented by means of software. FIG. 2 shows an object detection apparatus 455 stored in a memory 450, which may be software in the form of a program, a plug-in, etc. The object detection apparatus 455 includes the following software modules: a first determination module 4551, a second determination module 4552, and a result determination module 4553. These modules are logical modules, and thus can be arbitrarily combined or further split according to the functions implemented. Functions of the modules are described hereinafter.

In some other embodiments, the object detection apparatus provided by the embodiments of the present disclosure may be implemented by means of hardware. As an example, the object detection apparatus provided by the embodiments of the present disclosure may be a processor in the form of a hardware decoding processor, which is programmed to execute the object detection method provided by the embodiments of the present disclosure. For example, the processor in the form of the hardware decoding processor may use one or more Application Specific Integrated Circuits (ASIC), Digital Signal Processors (DSP), Programmable Logic Devices (PLD), Complex Programmable Logic Devices (CPLD), Field-Programmable Gate Arrays (FPGA), or other electronic elements.

In some embodiments, the terminal or the server may implement the object detection method provided by the embodiments of the present disclosure by running various computer-executable instructions or computer programs. For example, the computer-executable instructions may be commands, machine instructions, or software instructions at the microprogram level. The computer program may be a native program or a software module in an operating system. The computer program may be a native application (app), that is, a program that can be run only after being installed in an operating system, for example, an app on which object detection needs to be performed. Alternatively, the program may be a small program that can be embedded into any app, that is, a program that can be run only by downloading the program to a browser environment. In general, the computer-executable instructions may be an instruction in any form, and the computer program may be an app, module, or plug-in in any form.

The object detection method provided by the embodiments of the present disclosure will be described below with reference to the accompanying drawings. As described previously, the electronic device 400 for implementing the object detection method provided by the embodiments of the present disclosure may be a terminal 401, a server 200, or a combination of the two. Therefore, an execution object of each step will not be described repeatedly below.

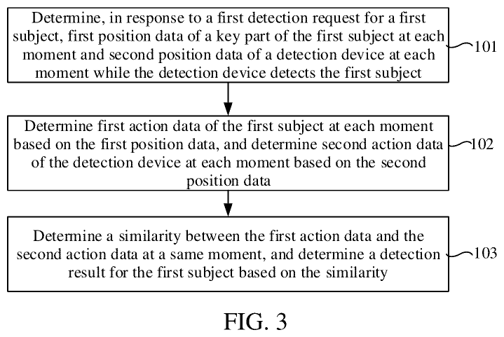

The object detection method provided by the embodiments of the present disclosure is described with an execution object being the server 200 and the terminal 401 being a detection device as an example. Referring to FIG. 3, FIG. 3 is a schematic flowchart of an object detection method provided by the embodiments of the present disclosure. The method is described with reference to steps shown in FIG. 3.

In step 101, first position data of a key part of the first object at each moment and second position data of a detection device at each moment while the detection device detects the first object are determined in response to a first detection request for a first object.

The first position data of the key part of the first object at each moment is sorted in chronological order and then stored in the form of a sequence, which is denoted as a first position sequence. The second position data of the detection device at each moment is also sorted in chronological order and stored in the form of a sequence, which is recorded as a second position sequence.

Here, the first object may be a person or an animal for liveness detection. The liveness detection is usually performed by photographing a face of the first object, and after the detection is completed, the server 200 is used to perform detection on the detection video of the first object based on the object detection method of the embodiments of the present disclosure, thereby determining a detection result for the first object.

In some embodiments, before the response to the first detection request for the first object, the server 200 may implement the detection process of the first object with the terminal 401 (the detection device) in the following manner: in response to a detection start request of the detection device, generating a service identifier of an object detection service and a detection box set based on a device identifier of the detection device, and sending the service identifier and the detection box set to the detection device, wherein the detection box set includes at least two detection boxes, and different detection boxes correspond to different third position data; and in response to a second detection request of the detection device for a first detection frame, in the case of determining that a display position of the first object in the first detection box matches a preset position, sending a detection instruction to the detection device, so that the detection device continues to trigger a third detection request for a second detection box based on the detection instruction until the detection device completes detection of the first object, and obtains the first detection request for the first object.

In actual implementation, a client capable of performing liveness detection is installed in the terminal 401, and when the first object uses the client, if the client needs to perform operations such as identity verification on the first object, the terminal 401 is used as a detection device to start a liveness detection process on the first object.

In actual implementation, before starting the liveness detection on the first object, the detection device may send a detection start request carrying the device identifier of the detection device to the server, to obtain the detection box set to render a detection box on an graphical interface to perform the liveness detection on the first object.

In actual implementation, before the detection device starts the liveness detection on the first object, the detection device may further send a detection start request carrying a unique genetic code to the server, to obtain the detection box set to render the detection box on the graphical interface to perform the liveness detection on the first object. Here, the unique genetic code is obtained by the detection device performing aggregation hash calculation according to basic information such as its own device identifier and timestamp.

In actual implementation, the server receives and responds to the detection start request of the detection device, parses the detection start request, acquires the device identifier (or the unique genetic code) carried in the detection start request, determines the timestamp when the detection start request is received and the Internet Protocol Address (IP address) of the detection start request, and then performs an aggregation hash operation on the device identifier (or the unique genetic code), the timestamp, and the IP address to obtain the service ID (i.e., the service identifier) of a current object detection service of the detection device for the first object. Also, the server further generates a detection box set. The detection box set may be a list of which the length is greater than 2, that is, the list includes more than 2 list elements, and one list element represents one detection box. That is to say, the detection box set includes at least two detection boxes. Here, the list element may be represented as a 2-tuple in which two elements represents the position of the detection box and the size of the detection box, respectively. The position may be represented by using coordinates. If the detection box is a circle, the size is represented as a radius, and if the detection box is a polygon, the size is represented as a width and a length. The data types of the position and the size are both floating point numbers. It can be understood that the position and size of the detection box in the list element are the third position data corresponding to the detection box.

In actual implementation, the server may store the generated service identifier and detection box set in a database while sending the service identifier and the detection box set to the detection device.

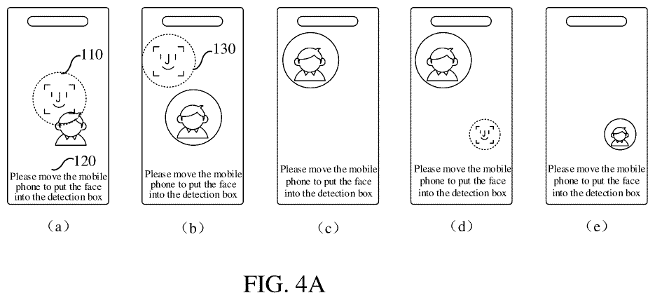

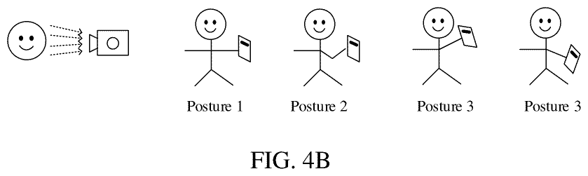

In actual implementation, after receiving the service identifier and the detection box set, the detection device may parse the detection box set, then, render any detection box in the detection box set based on the third position data of the detection box, and display the detection box on the graphical interface. FIG. 4A is a schematic diagram of displaying a detection box by the detection device provided by the embodiments of the present disclosure. Referring to FIG. 4A, as shown in (a) of FIG. 4A, the detection device may display an initially rendered first detection box 110 on a graphical interface, and guide, by using a text prompt 120, a first object to move the detection device to place a specified part (for example, a face) in the first detection box for detection. If the detection device is a mobile phone and the first object is a user object, the text prompt may be “Please move the mobile phone to put the face into the detection box.” In a process in which the detection device detects the first object by using the first detection box, a media stream (that is, a detection video) photographed for the first object may be transmitted to the server, and a second detection request for the first detection box is triggered, so that the server performs key part recognition on the first object based on the media stream, and at the same time, calculates whether the display position of the key part of the first object in the first detection box matches a preset position. If it is determined that the display position matches the preset position, the server sends a detection instruction (used to instruct the detection device to continue detection) to the detection device. The detection device renders a second detection box based on the third position data of the second detection box in the detection box set in response to the detection instruction. As shown in (b) of FIG. 4A, the second detection box 130 is displayed on the graphical interface, and the first object is guided, by using a text prompt, to continue to move the detection device to put the face into the second detection box 130. Similarly, in the process of detection by means of the second detection box, the detection device transmits the collected media stream to the server, and triggers a third detection request for the second detection box. When the server confirms that the display position of the key part of the first object in the second detection box matches the preset position, referring to (c) to (e) of FIG. 4A, the detection device continues to render a new detection box based on the detection box set until the detection device completes the detection of the first object, and triggers the generation of the first detection request for the first object, so that the server performs object detection on the first object based on the detection video of the entire detection process in response to the first detection request, and determines the detection result of liveness recognition for the first object.

In actual implementation, FIG. 4B is a schematic diagram of a first object moving a detection device provided by the embodiments of the present disclosure. Referring to FIG. 4B, in a process in which the first object executes detection by using the detection device, the detection device may be moved by using an arm in various postures shown in FIG. 4B, to interact with the detection box displayed in the graphical interface.

It should be noted that, in the detection process, the detection request (for example, the second detection request or the third detection request) triggered for each detection box is used to detect whether the display position of the first object in the detection box is accurate, for example, whether the face of the first object is displayed within the detection box. After the detection is completed, the first detection request triggered for the first object is to determine the detection result of whether the first object is liveness by using an object detection method based on the detection video of the entire detection process.

In the foregoing way, the detection device displays detection boxes at different positions, so that the first object interacts with the detection box by moving the detection device. The detection process is simple, so that the user does not need to make a complex action or receive colorful light, achieving better user experience. Moreover, by randomly moving the position of the detection box, the user needs to follow the moving detection box and make a response (that is, the detection device is moved along with the position of the detection box), which can also effectively prevent brute-force attacks and improve the reliability of liveness detection performed on the user.

In some embodiments, the first detection request carries a service identifier, and step 101 shown in FIG. 3 may further be implemented in the following manner: in response to a first detection request for a first object, determining a first time at which the first detection request is received, and a second time at which a service identifier is generated; and in the case that a time interval between the first time and the second time is less than an interval threshold, determining the first position data of the first object and the second position data of the detection device when the detection device detects the first object.

In actual implementation, after completing the detection, the first detection request for the first object sent by the detection device to the server carries the service identifier generated by the server for the current object detection service. After receiving the first detection request, the server first obtains a service identifier in response to the first detection request, compares the service identifier with a service identifier stored in a database for verification, and after verifying that the two are consistent, may determine the first time when the first detection request is received and the second time when the server generates the service identifier, and determine whether the time interval between the first time and the second time exceeds a preset interval threshold (for example, 1 minute). Here, the first time may be understood as an end time of the current object detection service for the first object, the second time may be understood as a start time of the current object detection service, and the time interval between the first time and the second time is a duration of the current object detection service. If the time interval is greater than the interval threshold, it indicates that the current detection process for the first object times out, which may be regarded as an invalid detection. There is no need to confirm the detection result for the current detection process, and the detection device may send a prompt of “The current detection is invalid, and please perform detection again” to the first object. If the time interval is less than the interval threshold, it indicates that the current detection process does not time out and is a valid detection process, the first position data of the first object and the second position data of the detection device when the detection device detects the first object can be determined, and object detection is performed based on the first position data and the second position data to determine the detection result of the current detection.

In actual implementation, the first position sequence of the first object includes first position data of the key part of the first object at each moment being detected, and the second position sequence includes second position data of the detection device being moved at each moment.

In the foregoing way, the time threshold is set to determine whether the time interval between the first time and the second time exceeds the time threshold, so that a user can be prevented from performing an attack (for example, a replay attack) by using a long-duration detection window. Once the detection is determined to have timed out, re-detection can be requested, increasing the difficulty of the attack. Moreover, because resources of some detection devices are limited, the time threshold is set so that the detection duration can be reduced, thereby saving the computing resources, and providing the detection efficiency.

In some embodiments, “determining, when the detection device detects the first object, the first position data of the key part of the first object at each moment” in step 101 shown in FIG. 3 may be implemented in the following manner:

parsing the first detection request to obtain a detection video of the first object; extracting video frames from the detection video to obtain a sequence of video frames; and extracting the key part from the video frames to obtain first position data of the key part in the video frames.

In actual implementation, in the process of detecting the first object, the detection device transmits, to the server, a media stream (that is, a detection video) collected for the first object in the detection process, and therefore, the first position sequence of the first object needs to be obtained by means of the detection video.

In actual implementation, the server may parse the first detection request to obtain a detection video of the entire detection process collected by the detection device when the detection device detects the first object, and perform video frame extraction on the detection video based on a frame rate of the detection video to obtain a video frame sequence of the detection video. Based on the duration, start time, end time, and frame rate of the detection video, a timestamp corresponding to each video frame may be determined, and a corresponding timestamp is marked for each video frame in the video frame sequence, wherein the timestamp corresponding to the video frame is a moment corresponding to the video frame.

In actual implementation, for each video frame in the video frame sequence, key part extraction is performed on the first object displayed in the video frame to obtain a two-dimensional coordinate position (x, y) of each key part in the video frame, and the two-dimensional coordinate position determined for each key part is used as the first position data of each key part. The first position data extracted for the key part in each video frame is combined in chronological order based on the order of each video frame and the timestamp corresponding to each video frame, and the timestamp of the corresponding video frame is marked to obtain the first position sequence.

Here, the extracted key parts are different according to the type of the detected first object and a detected part.

As an example, with the first object being a human being and the detected part being a face (i.e., a human face) as an example, the first position data of at least three key parts of the left eye, the right eye, and the mouth of the first object may be extracted.

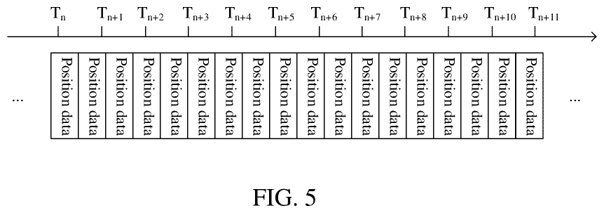

As an example, FIG. 5 is a schematic diagram of a data structure of position data provided by the embodiments of the present disclosure. Referring to FIG. 5, after the first position sequence is obtained, the first position data at each moment may be stored based on the form as shown in FIG. 5, wherein Tₙ, Tₙ₊₁ . . . . Tₙ₊₁₁ represent the timestamps marked at the respective moments.

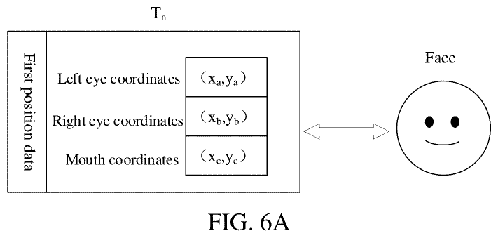

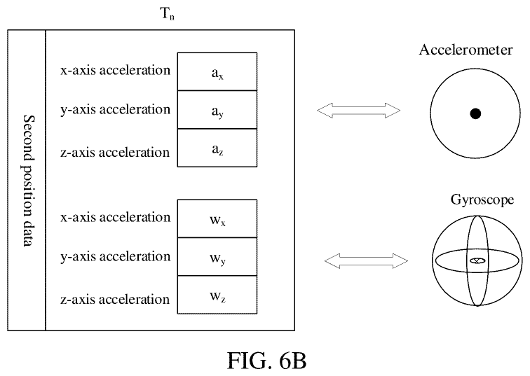

As an example, FIG. 6A is a schematic diagram of a data structure of first position data provided by the embodiments of the present disclosure. Referring to FIG. 6A, it is assumed that coordinate positions of three key parts, namely, the left eye, the right eye, and the mouth, are extracted for a first object. With the first position data at a certain moment in the first position sequence as an example, the first position data corresponding to the moment may include the coordinates (xₐ, yₐ) of the left eye, the coordinates (x_{b}, y_{b}) of the right eye, and the coordinates (x_{c}, y_{c}) of the mouth.

With continued reference to FIG. 3, the description will be continued with step 101 described above.

In step 102, first action data of the first object at each moment is determined based on the first position data, and second action data of the detection device at each moment is determined based on the second position data.

In some embodiments, “determining first action data of the first object at each moment based on the first position data” in step 102 shown in FIG. 3 may be implemented in the following manner: determining a first rotational speed and a first movement acceleration of the first object at each moment based on the first position data; and combining the first rotational speed and the first movement acceleration of the first object at each moment to obtain the first action data of the first object at each moment.

Here, since the process of the first object performing the liveness detection by means of the detection device is a process of making a specified part (for example, a face) of the first object interact with the detection box displayed in the detection device by continuously moving the detection device, the display position of the face of the first object in the detection device moves along with the detection box. Moreover, in the moving process, the face image of the first object displayed in the detection device is not necessarily forward due to face turning or rotation of the detection device.

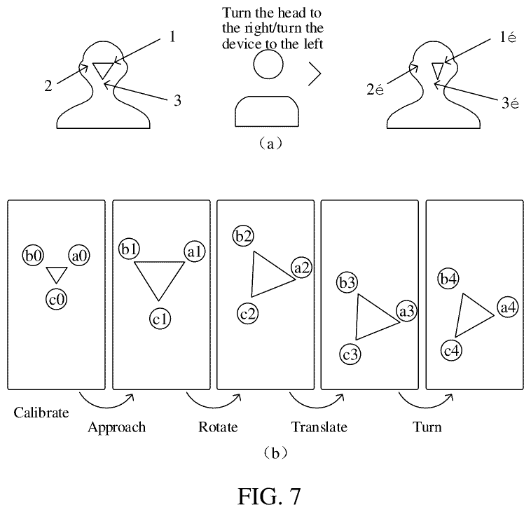

As an example, referring to FIG. 7, FIG. 7 is a schematic diagram of a display screen of a first object in a detection device provided by the embodiments of the present disclosure. As shown in (a) of FIG. 7, in the detection process, if the first object faces the detection device in the forward direction, the display positions of the three key parts (the left eye 1, the right eye 2, and the mouth 3) of the first object are normal, and if the first object turns right or the detection device is turned to the left, the display positions of the three key parts of the first object in the detection device will shift, and the three key parts (the left eye 1′, the right eye 2′, and the mouth 3′) are closer to each other. Moreover, in the detection process, if the face of the first object is far away from the detection device, the face displayed in the detection device becomes smaller, and the positions of the three key parts are close to each other. If the first object is close to the detection device, the face displayed in the detection device becomes larger, and the positions of the three key parts are dispersed. As shown in (b) of FIGS. 7, a0, a1, a2, a3, and a4 respectively represent left eye key parts in different video frames, b0, b1, b2, b3, and b4 respectively represent right eye key parts in different video frames, and c0, c1, c2, c3, and c4 respectively represent mouth key parts in different video frames. Referring to (b) of FIG. 7, in the process of detecting the first object by the detection device, the collected face image may have the following changes: the face image becomes larger due to approaching; the positions of the three key parts are correspondingly rotated due to the rotation of the face; the display position of the face image in the detection device is moved as the detection box moves; and the display image of the face image in the detection device is distorted due to turning.

It can be seen that, in the detection process, the change of the face image of the first object displayed in the detection device is associated with the action of the detection device to a certain extent. For example, the display position of the face image also moves up and down due to the detection device being moved up and down. For another example, the display of the face image is distorted to the left or right due to the detection device being rotated left or right.

Therefore, for the liveness detection manner for the first object in the embodiments of the present disclosure, whether the first object is liveness may be determined by detecting the consistency of actions between the first object and the detection device. That is, the action consistency determination may be performed based on the first action data of the first object and the second action data of the detection device at each moment. The first action data may be calculated and obtained from the first position data, and the second action data may be determined based on the second position data.

However, it can be seen from the above analysis that, in the detection process, the first object or the detection device usually involves two actions, i.e., movement and rotation, which may cause the face image displayed by the first object in the detection device to change significantly. That is, the display of the three key parts in the face image may change significantly. Therefore, when the action consistency determination between the first object and the detection device is performed, the action determination may be performed by using the rotation-related data and the movement-related data as the action data.

In actual implementation, for a movement action, since a movement acceleration is a measure of a velocity change, a sudden change in the action can be detected even when the movement velocity is low, and different movement actions are accompanied by different acceleration change patterns. For example, for some tiny movement actions, the velocity change may not be large, but the movement acceleration change is significant. The movement acceleration can better capture these tiny movement actions, and therefore, the movement acceleration can be used as the action data.

In actual implementation, for rotation, the rotational speed is a direct indicator for measuring the strength of the rotation action, and it can intuitively reflect the speed of the rotation action. The rotational speed may be quantified by means of an angular velocity (angle change rate), which facilitates numerical analysis and comparison. Moreover, the rotational speed is applicable to various rotation actions, regardless of the rotation of the detection device or the rotation action of the first object, and therefore, the rotational speed may be used as the action data.

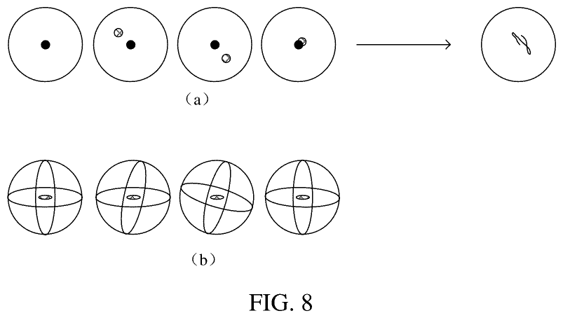

In actual implementation, FIG. 8 is a schematic diagram of an accelerometer and a gyroscope provided by the embodiments of the present disclosure. Referring to FIG. 8, the terminal 401 used as a detection device is usually configured with an accelerometer and a gyroscope, wherein the accelerometer is an inertial sensor. Therefore, the accelerometer may measure a movement acceleration of the detection device in space, namely, accelerations in three directions (horizontal, vertical, and depth). (a) of FIG. 8 shows a process in which the accelerometer collects the movement acceleration of the detection device. The gyroscope is a sensor for measuring an angular velocity, and may detect angular velocities and direction changes of the detection device around three axis directions (an x-axis, a y-axis, and a z-axis), thereby obtaining rotational speeds in the three axis directions. (b) of FIG. 8 shows a process in which the gyroscope collects the rotational speeds of the detection device. Therefore, when object detection is required, the rotational speed and the movement acceleration of the detection device at each moment in the corresponding detection process may be directly acquired as the second position data at each moment, thereby obtaining the second position sequence of the detection device.

As an example, the second position sequence of the detection device may also be stored in the data structure shown in FIG. 5. FIG. 6B is a schematic diagram of a data structure of second position data provided by the embodiments of the present disclosure. Referring to FIG. 6B, with second position data at a moment as an example, the second position data corresponding to the moment may include movement accelerations in all axis directions (that is, all directions) collected by an accelerometer, such as an x-axis acceleration aₓ, a y-axis acceleration a_{y}, and a z-axis acceleration a_{z}, and further include the rotational speed in each axis direction collected by the gyroscope, such as an x-axis rotational speed wₓ, a y-axis rotational speed w_{y}, and a z-axis rotational speed w_{z}.

Therefore, the second action data of the detection device at each moment may be directly obtained by means of the second position sequence, and the second action data includes a second rotational speed and a second movement acceleration of the detection device. Since the first position data in the first position sequence of the first object is the coordinate position of the key parts, for the first object, it is also necessary to calculate and obtain a first rotational speed and a first movement acceleration of the first object at each moment (i.e., every moment) based on the first position data in the first position sequence, and combine the first rotational speed and the first movement acceleration of the first object at each moment to obtain the first action data of the first object at each moment.

In some embodiments, the server 200 may determine the first rotational speed of the first object at each moment in the following manner: for a first moment and a second moment that are adjacent, determining a first plane of the first object at the first moment based on the first position data of the first object at the first moment, and determining a second plane of the first object at the second moment based on the first position data of the first object at the second moment; the second moment being a previous moment of the first moment; determining a rotation angle between the first plane and the second plane with a preset reference plane as a reference; and determining a time interval between the first moment and the second moment, and determining a ratio of the rotation angle to the time interval as the first rotational speed of the first object at the first moment.

In actual implementation, since the rotational speed reflects a process of rotation change, when the first rotational speed of the first object at each moment is calculated, the first rotational speed of the first object at each moment may be calculated by means of rotation between two adjacent moments.

As an example, for the first moment and the second moment that are adjacent in the moments, the second moment is the previous moment of the first moment, and when the first rotational speed of the first object at the first moment is calculated, the first rotational speed of the first object at the first moment may be calculated and obtained based on the rotation angle of the first object from the second moment to the first moment and the time interval between the two moments.

In actual implementation, the first position data of the first object includes coordinate positions of at least three key parts, and the three points form a plane. Therefore, the first plane of the first object at the first moment may be determined based on the first position data of the first object at the first moment, and the second plane of the first object at the second moment may be determined based on the first position data of the first object at the second moment. Since each piece of first position data of the first object is separately extracted from each video frame and there is no uniform spatial coordinate, a reference plane may be selected, and the rotation angle between the first plane and the second plane in the uniform space may be determined with the reference plane as a reference.

Here, a plane formed by key parts in a first video frame in the video frame sequence may be selected as the reference plane. It is also possible to determine a video frame meeting a requirement in the video frame sequence based on a specified detection manner, and use a plane formed by selected key parts in the video frame as the reference plane. The reference plane may be specifically determined based on an actual situation, which is not limited herein.

In actual implementation, when the rotation angle between the first plane and the second plane is determined with the reference plane as a reference, the rotation angle in an x-axis direction (that is, a horizontal axis direction), the rotation angle in a y-axis direction (that is, a vertical axis direction), and the rotation angle in a z-axis direction (that is, a depth axis direction) may be calculated separately; and then, the ratio of the rotation angle in the x-axis direction to the time interval is used as the rotational speed of the first object in the x-axis direction at the first moment, the ratio of the rotation angle in the y-axis direction to the time interval is used as the rotational speed of the first object in the y-axis direction at the first moment, and the ratio of the rotation angle in the z-axis direction to the time interval is used as the rotational speed of the first object in the z-axis direction at the first moment. Finally, the rotational speeds of the three axes are combined to obtain the first rotational speed of the first object at the first moment.

In some embodiments, the server 200 may determine the rotation angle between the first plane and the second plane with the preset reference plane as a reference in the following manner: determining a first rotation angle from the first plane to the reference plane and a second rotation angle from the second plane to the reference plane with the reference plane as the reference; determining a second normal vector of the first plane based on a first normal vector of the reference plane and the first rotation angle, and determining a third normal vector of the second plane based on the first normal vector and the second rotation angle; and performing a dot product operation on the second normal vector and the third normal vector, and determining the rotation angle between the first plane and the second plane based on a result of the dot product operation.

In actual implementation, the reference plane is preset, and the first normal vector of the reference plane is known. Therefore, the real normal vector of the plane at each moment may be calculated and obtained based on the rotation angle from the plane of the first object to the reference plane at each moment and the first normal vector of the reference plane.

As an example, the normal vectors of the plane of the first object at each moment may be calculated in the following manner, and the first plane at the first moment is taken as an example for description.

It is assumed that the coordinates of three key parts in the first position data of the first object at the first moment are \vec{a}=(xₐ, yₐ), \vec{b}=(x_{b}, y_{b}), and \vec{c}=(x_{c}, y_{c}), respectively; Then, the depth coordinate of each key part may be calculated and obtained based on an image-based depth detection algorithm, that is, the coordinate in the z direction, thereby obtaining the three-dimensional coordinates \vec{a}′=(xₐ, yₐ, zₐ), \vec{b}′=(x_{b}, y_{b}, z_{b}), and \vec{c}′=(x_{c}, y_{c}, z_{c}) of each key parts. A plane formed by key part in a first video frame in the detection video is selected as a reference plane, and it is assumed that a normal vector of the reference plane is \vec{nₚ}=(0,0,1). An initial normal vector \vec{n}=(\vec{b}′−\vec{a}′)×(\vec{c}′−\vec{a}′) of the first plane can be obtained based on the three-dimensional coordinates of the three key parts forming the first plane.

Based on the above normal vector, a rotation axis \vec{k}=\vec{n}×\vec{nₚ}, a rotation angle cos

$$θ = \frac{\vec{n} \cdot \vec{{n}_{p}}}{‖ \vec{n} ‖ ‖ \vec{{n}_{p}} ‖} ,$$

and a unit matrix

$$\vec{I} = [ \begin{matrix}1 & 0 & 0 \\ 0 & 1 & 0 \\ 0 & 0 & 1\end{matrix} ]$$

can be determined, and then a rotation matrix \vec{R}=\vec{I}+sin θ·\vec{K}+(1−cos θ)·\vec{K}² can be determined, wherein \vec{K} is an antisymmetric matrix of the rotation axis \vec{k}.

By rotating the three key parts of the first plane by means of the rotation matrix, new coordinates \vec{a}″=\vec{R}·\vec{a}′, \vec{b}″=\vec{R}·\vec{b}′, and \vec{c}″=\vec{R}·\vec{c}′ of the three key parts can be obtained, and \vec{a}″=(xₐ″, yₐ″, zₐ″), \vec{b}″=(x_{b}″, y_{b}″, z_{b}″), and \vec{c}″=(x_{c}″, y_{c}″, z_{c}″) can be calculated and obtained.

A projection ΔA′B′C′ on an XY plane is obtained by taking x and y parts of coordinates of three key parts after rotation, and the three side lengths of the projection are, respectively:

$${A}^{′} {B}^{′} = \sqrt{{( {x}_{b}^{″} - {x}_{a}^{″} )}^{2} + {( {y}_{b}^{″} - {y}_{a}^{″} )}^{2}}$$

$${B}^{′} {C}^{′} = \sqrt{{( {x}_{c}^{″} - {x}_{b}^{″} )}^{2} + {( {y}_{c}^{″} - {y}_{b}^{″} )}^{2}}$$

$${C}^{′} {A}^{′} = \sqrt{{( {x}_{a}^{″} - {x}_{c}^{″} )}^{2} + {( {y}_{a}^{″} - {y}_{c}^{″} )}^{2}}$$

The three side lengths of a triangle AABC formed by three key parts in the reference plane are, respectively:

$$\sqrt{AB = {( {x}_{bini} - {x}_{aini} )}^{2} + {( {y}_{bini} - {y}_{aini} )}^{2}}$$

$$\sqrt{BC = {( {x}_{cini} - {x}_{bini} )}^{2} + {( {y}_{cini} - {y}_{bini} )}^{2}}$$

$$\sqrt{CA = {( {x}_{aini} - {x}_{cini} )}^{2} + {( {y}_{aini} - {y}_{cini} )}^{2}}$$

A gradient search algorithm is used to perform search for zₐ, z_{b}, and z_{c}, so that

$$\vert \frac{{A}^{′} {B}^{′}}{AB} - \frac{{B}^{′} {C}^{′}}{BC} \vert + \vert \frac{{B}^{′} {C}^{′}}{BC} - \frac{{C}^{′} {A}^{′}}{CA} \vert < threshold ,$$

thereby obtaining optimal zₐ, z_{b}, and z_{c}. threshhold is used to define a plane obtained by rotating the first plane by using the rotation matrix to be more and more parallel to the reference plane. The smaller the value is set, the more parallel the rotated plane and the reference plane are, thereby obtaining more accurate zₐ, z_{b}, and z_{c}.

Finally, the obtained optimal zₐ, z_{b}, and z_{c} are substituted into the three-dimensional coordinates of the three key parts, respectively, to obtain real three-dimensional coordinates of the three key parts, and a real normal vector \vec{n} of the first plane, a second normal vector of the first plane, is calculated based on the real three-dimensional coordinates. Here, the first rotation angle of the first plane to the reference plane is cos θ calculated in the gradient search process.

In the foregoing way, the third normal vector of the first object on the second plane at the second moment may be calculated. Then, the rotation angle between the first plane and the second plane is determined based on the dot product operation of the second normal vector and the third normal vector.

As an example, the rotation angle between the first plane and the second plane may be calculated and obtained in the following manner:

It is assumed that the second normal vector of the first plane at the first moment t₀ calculated in the above manner is \vec{nₜ_{₀}}, and the third normal vector of the second plane at the second moment t₁ is \vec{nₜ_{₁}}. Then, the rotation amount \vec{u}=\vec{nₜ_{₀}}×\vec{nₜ_{₁}} can be calculated and obtained by means of dot product, and the components uₓ, u_{y} and u_{z} of the first object in respective axis directions are determined based on the second normal vector and the third normal vector.

Then, the rotation angle of each axis direction is calculated, and the rotation angle in the x axis is

$${θ}_{x} = arccos \frac{{u}_{x}}{‖ \vec{u} ‖} ,$$

the rotation angle in the y-axis direction is

$${θ}_{y} = arccos \frac{{u}_{y}}{‖ \vec{u} ‖} ,$$

and the rotation angle in the z-axis direction is

$${θ}_{z} = arccos \frac{{u}_{z}}{‖ \vec{u} ‖} .$$

Finally, the calculated and obtained rotation angle of each axis is used as the rotation angle between the first plane and the second plane.

As an example, the time interval between the first moment t₀ and the second moment t₁ is dt=|t₀−t₁|. Then, the rotational speed of the first object in each axis direction at the first moment, for example, the rotational speed

$${w}_{x} = \frac{{θ}_{x}}{dt}$$

in the x-axis direction, the rotation speed

$${w}_{y} = \frac{{θ}_{y}}{dt}$$

in the y-axis direction, and the rotational speed

$${w}_{z} = \frac{{θ}_{z}}{dt}$$

in the z-axis direction may be calculated and obtained based on the ratio of the rotation angle of each axis to the time interval. Then, the first rotational speed of the first object at the first moment may be represented as (wₓ, w_{y}, and w_{z}).

In some embodiments, the server 200 may determine the first movement acceleration of the first object at each moment based on the first position data in the following manner: for a third moment, a fourth moment, and a fifth moment that are adjacent, determining a first centroid position of the first object at the third moment, a second centroid position of the first object at the fourth moment, and a third centroid position of the first object at the fifth moment based on the corresponding first position data of the first object respectively at the third moment, the fourth moment, and the fifth moment; determining a movement acceleration of the first object corresponding to a horizontal direction at the fifth moment based on position changes of the first centroid position, the second centroid position, and the third centroid position in the horizontal direction; determining a movement acceleration of the first object corresponding to a vertical direction at the fifth moment based on position changes of the first centroid position, the second centroid position, and the third centroid position in the vertical direction; determining a third plane of the first object at the third moment, a fourth plane of the first object at the fourth moment, and a fifth plane of the first object at the fifth moment, and determining a movement acceleration of the first object corresponding to a depth direction at the fifth moment based on changes in area of the third plane, the fourth plane, and the fifth plane; and combining the movement acceleration of the first object corresponding to the horizontal direction, the movement acceleration of the first object corresponding to the vertical direction, and the movement acceleration of the first object corresponding to the depth direction at the fifth moment, to obtain the first movement acceleration of the first object at the fifth moment.

In actual implementation, the movement velocity between two adjacent moments can be determined based on the position changes of the first object at the two moments, and therefore, in order to obtain the movement acceleration at each moment, acceleration calculation may be performed based on the first position data of the first object at three adjacent moments.

In actual implementation, a plane of the first object at each moment may be represented by a point, and the movement acceleration is calculated by means of position changes of the point at different moments. Here, since the center of gravity is an average position of gravity action points of all key parts, the plane at each moment may be represented by selecting the center of gravity of the plane at each moment.

In actual implementation, the calculation formula of the center of gravity is usually:

$$\vec{G} = ( \frac{{x}_{a} + {x}_{b} + {x}_{c}}{3} , \frac{{y}_{a} + {y}_{b} + {y}_{c}}{3} ) .$$

Based on this formula, for the third moment, the fourth moment, and the fifth moment that are adjacent among the moments, the first centroid position \vec{G₁} of the first object at the third moment is calculated and obtained based on the first position data of the first object at the third moment, the second centroid position \vec{G₂} of the first object at the fourth moment is calculated and obtained based on the first position data of the first object at the fourth moment, and the third centroid position \vec{G₃} of the first object at the fifth moment is calculated and obtained based on the first position data of the first object at the fifth moment.

Here, when the position of the center of gravity is calculated, only the coordinate positions of each key part in the horizontal direction and the vertical direction are used. Therefore, the movement acceleration of the first object corresponding to the horizontal direction at the fifth moment may be determined based on the position changes of the first centroid position, the second center position, and the third center position in the horizontal direction during the time period from the third moment to the fifth moment, and the movement acceleration of the first object corresponding to the vertical direction at the fifth moment may be determined based on the position changes in the vertical direction. The third moment is a previous moment of the fourth moment, and the fourth moment is a previous moment of the fifth moment.

As an example, the movement acceleration may be calculated by means of the following formula:

First, the movement velocity

$${v}_{t 1} = \frac{d ( \vec{{G}_{t 1}} - \vec{{G}_{t 0}} )}{dt}$$

at each moment is calculated. Here, \vec{Gₜ₁} represents the centroid position at moment t1, \vec{Gₜ₀} represents the centroid position at moment t0, dt is the time interval from moment t1 to moment t0, d(\vec{Gₜ₁}−\vec{Gₜ₀}) represents the movement distance of the centroid position between the two moments, and vₜ₁ represents the movement velocity at moment t1. After obtaining the movement velocity at each moment, the movement acceleration at moment t1 can be obtained by means of

$${a}_{t 1} = \frac{d ( {v}_{t 1} - {v}_{t 0} )}{dt} .$$

As an example, with the timestamp 1700304000 of the third moment, the timestamp 1700304030 of the fourth moment, and the timestamp 1700304060 of the fifth moment as an example, the first position data corresponding to the three timestamps in the first position sequence of the first object is used to calculate and obtain the first centroid position at the third moment as \vec{G₁}=(0.5, 0.4667), the second centroid position at the fourth moment as \vec{G₂}=(0.5, 0.4733), and the third centroid position at fifth moment as \vec{G₃}=(0.5, 0.48). Then, the movement distance of the first object in the x direction from the third moment to the fourth moment is 0, and the movement distance of the first object in the x direction from the fourth moment to the fifth moment is 0. Thus, in the x direction, the movement velocity of the first object from the third moment to the fourth moment is 0, and the movement velocity of the first object from the fourth moment to the fifth moment is 0. Therefore, the movement acceleration of the first object in the x direction at the fifth moment is 0. The movement distance of the first object in the y direction from the third moment to the fourth moment is 0.0066, and the movement distance of the first object in the x direction from the fourth moment to the fifth moment is 0.0067. Then, in the y direction, the movement velocity of the first object from the third moment to the fourth moment is 0.00022 pp/ms, and the movement velocity of the first object from the fourth moment to the fifth moment is 0.00022 pp/ms. Therefore, the movement acceleration of the first object in the y direction at the fifth moment is 0. Here, the x direction represents a horizontal direction. The y direction represents a vertical direction.

In actual implementation, the movement acceleration of the first object in the depth direction may be determined by means of changes of areas of the first object at three adjacent moments.

As an example, it is known that the coordinates of three key parts of the first object at a certain moment are \vec{a}=(xₐ, yₐ), \vec{b}=(x_{b}, y_{b}), and \vec{c}=(x_{c}, y_{c}), respectively, and then, the area of the plane of the first object at each moment may be calculated by means of the following formula:

$$S = \frac{1}{2} \vert {x}_{a} ( {y}_{b} - {y}_{c} ) + {x}_{b} ( {y}_{c} - {y}_{a} ) + {x}_{c} ( {y}_{a} - {y}_{b} ) \vert$$

After the area of the plane of the first object at each moment is calculated and obtained by means of the above formula, the movement acceleration in the z direction may be calculated and obtained by means of the following formula:

$${a}_{t 1} = \frac{d ( \frac{{S}_{t 1}}{{S}_{t 0}} * C )}{dt} .$$

Here, C is an empirical coefficient, Sₜ₁ represents the area of the plane at moment t1, and Sₜ₀ represents the area of the plane at moment t0.

As an example, based on the above formula, the movement velocity of the first object in the z direction may be first calculated. It is assumed that the area of the third plane is calculated and obtained as S1=0.02, the area of the fourth plane is calculated and obtained as S2=0.0128, and the area S3 of the fifth plane is calculated and obtained as S3=0.0072. Then, the movement velocity of the first object in the z direction at the fourth moment may be obtained as 0.0267 cpp/ms, the movement velocity of the first object in the z direction at the fifth moment may be obtained as 0.025 cpp/ms, and finally, the first movement acceleration of the first object in the z direction at the fifth moment may be obtained as 0.00005667. Here, the z direction is a depth direction.

As an example, the first movement acceleration of the first object may be represented by means of (aₓ, a_{y}, a_{y}).

After the first action data (that is, the first rotational speed and the first movement acceleration) of the first object at each moment is calculated and obtained in the foregoing way, the timestamps of the first action data and the second action data of the detection device may be aligned to facilitate subsequent action consistency determination based on action data at the same moment.

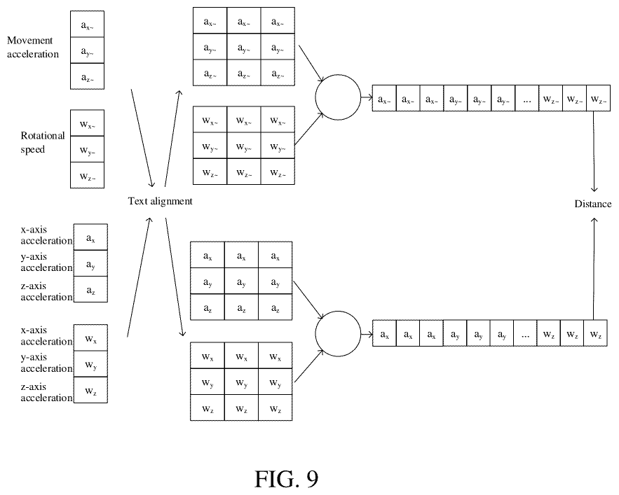

As an example, FIG. 9 is a schematic diagram of data alignment provided by the embodiments of the present disclosure. Referring to FIG. 9, timestamp alignment may be performed on the first action data and the second action data based on the data alignment manner shown in FIG. 9.

In the foregoing way, when the action data detection is performed on the first object and the detection device, comprehensive information regarding action states of the first object and the detection device can be provided by considering both the rotational speed and the movement acceleration, which is helpful to more accurately determine the consistency of the action. Moreover, the rotational speed and the movement acceleration are direct physical quantities describing the action state, and the two parameters can be quickly acquired by means of the method in the above embodiment, so that the determination of the action consistency can be performed immediately, thereby improving the efficiency of object detection. By using the two parameters at the same time, the rotational speed and the movement acceleration may provide motion information in different aspects, which may be complementary to each other, so that the server is more robust to external interference and noise, thereby ensuring the accuracy of the detection result for the first object.

With continued reference to FIG. 3, the description will be continued with step 102 described above.

In step 103, a similarity between the first action data and the second action data at the same time is determined, and a detection result for the first object is determined based on the similarity.

In some embodiments, “determining a detection result for the first object based on the similarity” in step 103 shown in FIG. 3 may be implemented in the following manner: determining sixth moments corresponding to similarities greater than a similarity threshold, and determining the number of sixth moments; and determining, in the case that the number of sixth moments is greater than a number threshold, the detection result to be that the first object is liveness.

In actual implementation, the action consistency, that is, the dynamic behavior consistency, of the first object and the detection device at each moment may be determined based on the first action data and the second action data after the timestamp alignment.

As an example, for each moment, the first action data (wₓ₁, w_{y1}, w_{z1}, aₓ₁, a_{y1}, a_{y1}) at the corresponding moment and the second action data (wₓ₂, w_{y2}, w_{z2}, aₓ₂, a_{y2}, a_{y2}) at the corresponding moment are acquired. Then, the cosine distance between the first action data and the second action data is calculated, and the similarity between the first action data and the second action data is determined based on the cosine distance between the two. When the similarity is greater than the similarity threshold, it is determined that the action of the first object at that moment in the detection video is consistent with the action of the detection device at that moment.

The similarities between the first object and the detection device at a plurality of moments are calculated based on this manner, and a sixth moment at which the similarity is greater than a similarity threshold is determined. If the number of sixth moments is greater than the number threshold, it indicates that the action change of the first object in the detection process basically corresponds to the action change of the detection device, and therefore, it may be determined that the first object is a detection result of liveness. If the number of the sixth moment is less than the number threshold, a detection result that the first object is not liveness may be obtained.

In actual implementation, in addition to determining a detection result as to whether the first object is liveness by using the object detection method in the embodiments of the present disclosure, the detection video may be further recognized in combination with an anti-counterfeiting large model, and whether the first object is liveness is jointly determined based on the detection result in the embodiments of the present disclosure and a result of the anti-counterfeiting large model.

By means of the above embodiments, after the detection device completes the detection of the first object, in response to the first detection request for the first object, the first action data of the first object at each moment and the second action data of the detection device at each moment can be determined based on the first position data of the key part of the first object at each moment and the second position data of the detection device at each moment while the detection device detects the first object, and the liveness detection result of the first object is determined based on the similarity between the action data of the two at the same moment. In this way, since the detection device is moved by the first object when detecting the first object, and the actions of the two at the same moment correspond to each other, the actions of the first object and the detection device are inverted by means of action data, and the similarity of the actions of the two at the same moment is used as the determination basis, so that even if the first object makes an erroneous operation during the detection process, the consistency of the actions of the two can reduce the occurrence of misrecognition, thereby improving the robustness of liveness detection for the first object.

Moreover, an attacking object cannot accurately simulate the action information of the first object and the detection device at the same time, that is, it cannot perform an accurate physical operation on the detection device, so that it is also more difficult to inject an attack, because even if an attacker successfully completes the detection process, the server can detect the injection attack by using the object detection method in the embodiments of the present disclosure after receiving the detection video.

The following continues to describe an exemplary structure in which the object detection apparatus 455 provided by the embodiments of the present disclosure is implemented as software modules. In some embodiments, as shown in FIG. 2, the software modules stored in the object detection apparatus 455 of the memory 450 may include:
a first determination module 4551, which is configured to: determine, in response to a first detection request for a first object, first position data of a key part of the first object at each moment and second position data of a detection device at each moment while the detection device detects the first object;
a second determination module 4552, which is configured to: determine first action data of the first object at each moment based on the first position data, and determine second action data of the detection device at each moment based on the second position data; and
a result determination module 4553, which is configured to: determine a similarity between the first action data and the second action data at a same moment, and determine a detection result for the first object based on the similarity.

In some embodiments, the first determination module 4551 is further configured to: parse the first detection request to obtain a detection video of the first object set; perform video frame extraction on the detection video to obtain a sequence of video frames; and perform key part extraction on the video frames to obtain first position data of the key part in the video frames.

In some embodiments, the second determination module 4552 is further configured to: determine a first rotational speed and a first movement acceleration of the first object at each moment based on the first position data; and combining the first rotational speed and the first movement acceleration of the first object at each moment to obtain the first action data of the first object at each moment.

In some embodiments, the second determination module 4552 is further configured to: for the first moment and the second moment that are adjacent, determine a first plane of the first object at the first moment based on the first position data of the first object at the first moment, and determine a second plane of the first object at the second moment based on the first position data of the first object at the second moment; the second moment being a previous moment of the first moment; determine a rotation angle between the first plane and the second plane with a preset reference plane as a reference; and determining a time interval between the first moment and the second moment, and determining a ratio of the rotation angle to the time interval as the first rotational speed of the first object at the first moment.

In some embodiments, the second determination module 4552 is further configured to determine a first rotation angle from the first plane to the reference plane and a second rotation angle from the second plane to the reference plane with the reference plane as a reference. determine a second normal vector of the first plane based on a first normal vector of the reference plane and the first rotation angle, and determine a third normal vector of the second plane based on the first normal vector and the second rotation angle; and perform a dot product operation on the second normal vector and the third normal vector, and determine the rotation angle between the first plane and the second plane based on a result of the dot product operation.

In some embodiments, the second determination module 4552 is further configured to: for a third moment, a fourth moment, and a fifth moment that are adjacent, determine a first centroid position of the first object at the third moment, a second centroid position of the first object at the fourth moment, and a third centroid position of the first object at the fifth moment based on the corresponding first position data of the first object respectively at the third moment, the fourth moment, and the fifth moment; determine a movement acceleration of the first object corresponding to a horizontal direction at the fifth moment based on position changes of the first centroid position, the second centroid position, and the third centroid position in the horizontal direction; determine a movement acceleration of the first object corresponding to a vertical direction at the fifth moment based on position changes of the first centroid position, the second centroid position, and the third centroid position in the vertical direction; determine a third plane of the first object at the third moment, a fourth plane of the first object at the fourth moment, and a fifth plane of the first object at the fifth moment, and determine a movement acceleration of the first object corresponding to a depth direction at the fifth moment based on changes in area of the third plane, the fourth plane, and the fifth plane; and combine the movement acceleration of the first object corresponding to the horizontal direction, the movement acceleration of the first object corresponding to the vertical direction, and the movement acceleration of the first object corresponding to the depth direction at the fifth moment, to obtain the first movement acceleration of the first object at the fifth moment.

In some embodiments, the result determination module 4553 is further configured to: determine sixth moments corresponding to similarities greater than a similarity threshold, and determine the number of sixth moments; determining, in the case that the number of sixth moments is greater than a number threshold, the detection result to be that the first object is liveness.

In some embodiments, the object detection apparatus 455 further includes a detection module configured to: in response to a detection start request of the detection device, generate a service identifier of an object detection service and a detection box set based on a device identifier of the detection device, and send the service identifier and the detection box set to the detection device, wherein the detection box set includes at least two detection boxes, and different detection boxes correspond to different third position data; and in response to a second detection request of the detection device for a first detection box, in the case of determining that a display position of the first object in the first detection box matches a preset position, send a detection instruction to the detection device, so that the detection device continues to trigger a third detection request for a second detection box based on the detection instruction until the detection device completes detection of the first object, and obtains the first detection request for the first object.

In some embodiments, the first determination module 4551 is further configured to: in response to the first detection request for the first object, determine a first time at which the first detection request is received, and a second time at which the service identifier is generated; and in the case that a time interval between the first time and the second time is less than an interval threshold, determine the first position data of the first object and the second position data of the detection device when the detection device detects the first object.

The embodiments of the present disclosure have the following beneficial effects: By means of the above embodiments, after the detection device completes the detection of the first object, in response to the first detection request for the first object, the first action data of the first object at each moment and the second action data of the detection device at each moment can be determined based on the first position data of the key part of the first object at each moment and the second position data of the detection device at each moment, and the liveness detection result of the first object is determined based on the similarity between the action data of the two at the same moment. In this way, since the detection device is moved by the first object when detecting the first object, and the actions of the two at the same moment correspond to each other, the actions of the first object and the detection device are inverted by means of action data, and the similarity of the actions of the two at the same moment is used as the determination basis, so that even if the first object makes an erroneous operation during the detection process, the consistency of the actions of the two can reduce the occurrence of misrecognition, thereby improving the robustness of liveness detection for the first object.

An embodiment of the present disclosure provides a computer program product, the computer program product including a computer program or computer-executable instructions, and the computer program or the computer-executable instructions being stored in a computer-readable storage medium. A processor of an electronic device reads the computer-executable instructions from the computer-readable storage medium, and the processor executes the computer-executable instructions to cause the electronic device to execute the object detection method described above in the embodiments of the present disclosure.

The embodiments of the present disclosure provide a computer-readable storage medium, having computer-executable instructions or a computer program stored therein. When the computer-executable instructions or the computer program is executed by a processor, the processor is caused to execute the object detection method provided by the embodiments of the present disclosure, such as the object detection method as shown in FIG. 3.

In some embodiments, the computer-readable storage medium may be a memory such as a RAM, a ROM, a flash memory, a magnetic surface memory, an optical disc, or a CD-ROM, or may be various devices including one or any combination of the above memories.

In some embodiments, the computer-executable instructions may be in the form of a program, software, software module, script or code, and written in any form of programming language (including a compiled or interpreted language, or a declarative or procedural language), and may be deployed in any form, including as a stand-alone program or as a module, component, subroutine, or another unit suitable for use in a computing environment.

As an example, the computer-executable instructions may, but does not necessarily, correspond to a file in a file system, and may be stored in a part of a file storing other programs or data, for example, in one or more scripts in a hyper text markup language (HTML) document, in a single file dedicated to the program in question, or in a plurality of coordinated files (for example, files storing one or more modules, sub-programs, or code portions).

As an example, the computer-executable instructions may be deployed to be executed on one electronic device, or on a plurality of electronic devices located at one site, or on a plurality of electronic devices distributed at a plurality of parts and interconnected by means of a communication network.

In summary, by means of the above embodiments, after the detection device completes the detection of the first object, in response to the first detection request for the first object, the first action data of the first object at each moment and the second action data of the detection device at each moment can be determined based on the first position data of the key part of the first object at each moment and the second position data of the detection device at each moment while the detection device detects the first object, and the liveness detection result of the first object is determined based on the similarity between the action data of the two at the same moment. In this way, since the detection device is moved by the first object when detecting the first object, and the actions of the two at the same moment correspond to each other, the actions of the first object and the detection device are inverted by means of action data, and the similarity of the actions of the two at the same moment is used as the determination basis, so that even if the first object makes an erroneous operation during the detection process, the consistency of the actions of the two can reduce the occurrence of misrecognition, thereby improving the robustness of liveness detection for the first object.

Moreover, an attacking object cannot accurately simulate the action information of the first object and the detection device at the same time, that is, it cannot perform an accurate physical operation on the detection device, so that it is also more difficult to inject an attack, because even if an attacker successfully completes the detection process, the server can detect the injection attack by using the object detection method in the embodiments of the present disclosure after receiving the detection video.

The foregoing are merely embodiments of the present disclosure, and are not intended to limit the scope of protection of the present disclosure. Any modifications, equivalent substitutions, improvements, etc. made within the spirit and scope of the present disclosure are encompassed within the scope of protection of the present disclosure.

1. An object detection method, comprising:
determining, in response to a first detection request for a first object, first position data of a key part of the first object at each moment and second position data of a detection device at each moment while the detection device detects the first object;
determining first action data of the first object at each moment based on the first position data, and determining second action data of the detection device at each moment based on the second position data; and
determining a similarity between the first action data and the second action data at a same moment, and determining a detection result for the first object based on the similarity.

2. The method of claim 1, wherein determining, when the detection device detects the first object, the first position data of the key part of the first object at each moment comprises:
parsing the first detection request to obtain a detection video of the first object;
extracting video frames from the detection video to obtain a sequence of the video frames; and
extracting the key part from the video frames to obtain first position data of the key part in the video frames.

3. The method of claim 1, wherein determining the first action data of the first object at each moment based on the first position data comprises:
determining a first rotational speed and a first movement acceleration of the first object at each moment based on the first position data; and
combining the first rotational speed and the first movement acceleration of the first object at each moment to obtain the first action data of the first object at each moment.

4. The method of claim 3, wherein determining the first rotational speed of the first object at each moment based on the first position data comprises:
for a first moment and a second moment that are adjacent, determining a first plane of the first object at the first moment based on the first position data of the first object at the first moment, and determining a second plane of the first object at the second moment based on the first position data of the first object at the second moment; the second moment being a previous moment of the first moment;
determining a rotation angle between the first plane and the second plane with a preset reference plane as a reference; and
determining a time interval between the first moment and the second moment, and determining a ratio of the rotation angle to the time interval as the first rotational speed of the first object at the first moment.

5. The method of claim 4, wherein determining the rotation angle between the first plane and the second plane with the preset reference plane as the reference comprises:
determining a first rotation angle from the first plane to the preset reference plane and a second rotation angle from the second plane to the preset reference plane by using the preset reference plane as the reference;
determining a second normal vector of the first plane based on a first normal vector of the preset reference plane and the first rotation angle, and determining a third normal vector of the second plane based on the first normal vector and the second rotation angle; and
performing a dot product operation on the second normal vector and the third normal vector, and determining the rotation angle between the first plane and the second plane based on a result of the dot product operation.

6. The method of claim 3, wherein determining the first movement acceleration of the first object at each moment based on the first position data comprises:
for a third moment, a fourth moment, and a fifth moment that are adjacent, determining a first centroid position of the first object at the third moment, a second centroid position of the first object at the fourth moment, and a third centroid position of the first object at the fifth moment based on the first position data of the first object at the third moment, the first position data of the first object at the fourth moment, and the first position data of the first object at the fifth moment, respectively;
determining a movement acceleration of the first object corresponding to a horizontal direction at the fifth moment based on position changes of the first centroid position, the second centroid position, and the third centroid position in the horizontal direction;
determining a movement acceleration of the first object corresponding to a vertical direction at the fifth moment based on position changes of the first centroid position, the second centroid position, and the third centroid position in the vertical direction;
determining a third plane of the first object at the third moment, a fourth plane of the first object at the fourth moment, and a fifth plane of the first object at the fifth moment, and determining a movement acceleration of the first object corresponding to a depth direction at the fifth moment based on changes in area of the third plane, the fourth plane, and the fifth plane; and
combining the movement acceleration of the first object corresponding to the horizontal direction, the movement acceleration of the first object corresponding to the vertical direction, and the movement acceleration corresponding to the depth direction at the fifth moment, to obtain the first movement acceleration of the first object at the fifth moment.

7. The method of claim 1, wherein determining the second action data of the detection device at each moment based on the second position data comprises:
determining a second movement acceleration collected by an accelerometer of the detection device at each moment as a first part of the second position data of the detection device at the moment;
determining a second rotational speed collected by a gyroscope of the detection device at each moment as a second part of the second position data of the detection device at the moment; and
obtaining the second action data of the detection device at each moment based on the first part and the second part of the second position data.

8. The method of claim 1, wherein determining a similarity between the first action data and the second action data at a same moment comprises:
for each moment, obtaining the first action data and the second action data at the moment;
calculating a cosine distance between the first action data and the second action data; and
determining the similarity between the first action data and the second action data based on the cosine distance between the first action data and the second action data.

9. The method of claim 1, wherein determining the detection result for the first object based on the similarity comprises:
determining a sixth moment corresponding to the similarity being greater than a similarity threshold, and determining a number of sixth moments; and
determining, in the case that the number of sixth moments is greater than a number threshold, that the detection result is that the first object is liveness.

10. The method of claim 1, wherein before the response to the first detection request for the first object, the method comprises:
in response to a detection start request of the detection device, generating a service identifier of an object detection service and a detection box set based on a device identifier of the detection device, and sending the service identifier and the detection box set to the detection device, wherein the detection box set comprises at least two detection boxes, and different detection boxes correspond to different third position data; and
in response to a second detection request of the detection device for a first detection box, in the case of determining that a display position of the first object in the first detection box matches a preset position, sending a detection instruction to the detection device, so that the detection device continues to trigger a third detection request for a second detection box based on the detection instruction until the detection device completes detection of the first object, and acquiring the first detection request for the first object.

11. The method of claim 10, wherein the first detection request carries the service identifier; and
in response to the first detection request for the first object, determining, when the detection device detects the first object, the first position data of the key part of the first object at each moment and the second position data of the detection device at each moment comprises:
in response to the first detection request for the first object, determining a first time at which the first detection request is received, and a second time at which the service identifier is generated; and
in the case that a time interval between the first time and the second time is less than an interval threshold, determining the first position data of the first object and the second position data of the detection device when the detection device detects the first object.

12. An electronic device, comprising:
a memory for storing computer-executable instructions or a computer program; and
a processor configured to execute the computer-executable instructions or the computer program stored in the memory to perform:
determining, in response to a first detection request for a first object, first position data of a key part of the first object at each moment and second position data of a detection device at each moment while the detection device detects the first object;
determining first action data of the first object at each moment based on the first position data, and determining second action data of the detection device at each moment based on the second position data; and
determining a similarity between the first action data and the second action data at a same moment, and determining a detection result for the first object based on the similarity.

13. The electronic device of claim 12, wherein determining, when the detection device detects the first object, the first position data of the key part of the first object at each moment comprises:
parsing the first detection request to obtain a detection video of the first object;
extracting video frames from the detection video to obtain a sequence of the video frames; and
extracting the key part from the video frames to obtain first position data of the key part in the video frames.

14. The electronic device of claim 12, wherein determining the first action data of the first object at each moment based on the first position data comprises:
determining a first rotational speed and a first movement acceleration of the first object at each moment based on the first position data; and
combining the first rotational speed and the first movement acceleration of the first object at each moment to obtain the first action data of the first object at each moment.

15. The electronic device of claim 14, wherein determining the first rotational speed of the first object at each moment based on the first position data comprises:
for a first moment and a second moment that are adjacent, determining a first plane of the first object at the first moment based on the first position data of the first object at the first moment, and determining a second plane of the first object at the second moment based on the first position data of the first object at the second moment; the second moment being a previous moment of the first moment;
determining a rotation angle between the first plane and the second plane with a preset reference plane as a reference; and
determining a time interval between the first moment and the second moment, and determining a ratio of the rotation angle to the time interval as the first rotational speed of the first object at the first moment.

16. The electronic device of claim 15, wherein determining the rotation angle between the first plane and the second plane with the preset reference plane as the reference comprises:
determining a first rotation angle from the first plane to the preset reference plane and a second rotation angle from the second plane to the preset reference plane by using the preset reference plane as the reference;
determining a second normal vector of the first plane based on a first normal vector of the preset reference plane and the first rotation angle, and determining a third normal vector of the second plane based on the first normal vector and the second rotation angle; and
performing a dot product operation on the second normal vector and the third normal vector, and determining the rotation angle between the first plane and the second plane based on a result of the dot product operation.

17. The electronic device of claim 14, wherein determining the first movement acceleration of the first object at each moment based on the first position data comprises:
for a third moment, a fourth moment, and a fifth moment that are adjacent, determining a first centroid position of the first object at the third moment, a second centroid position of the first object at the fourth moment, and a third centroid position of the first object at the fifth moment based on the first position data of the first object at the third moment, the first position data of the first object at the fourth moment, and the first position data of the first object at the fifth moment, respectively;
determining a movement acceleration of the first object corresponding to a horizontal direction at the fifth moment based on position changes of the first centroid position, the second centroid position, and the third centroid position in the horizontal direction;
determining a movement acceleration of the first object corresponding to a vertical direction at the fifth moment based on position changes of the first centroid position, the second centroid position, and the third centroid position in the vertical direction;
determining a third plane of the first object at the third moment, a fourth plane of the first object at the fourth moment, and a fifth plane of the first object at the fifth moment, and determining a movement acceleration of the first object corresponding to a depth direction at the fifth moment based on changes in area of the third plane, the fourth plane, and the fifth plane; and
combining the movement acceleration of the first object corresponding to the horizontal direction, the movement acceleration of the first object corresponding to the vertical direction, and the movement acceleration corresponding to the depth direction at the fifth moment, to obtain the first movement acceleration of the first object at the fifth moment.

18. The electronic device of claim 12, wherein determining the detection result for the first object based on the similarity comprises:
determining a sixth moment corresponding to the similarity being greater than a similarity threshold, and determining a number of sixth moments; and
determining, in the case that the number of sixth moments is greater than a number threshold, that the detection result is that the first object is liveness.

19. The electronic device of claim 12, wherein the processor is further configured to execute the computer-executable instructions or the computer program stored in the memory to:
before the response to the first detection request for the first object, in response to a detection start request of the detection device, generate a service identifier of an object detection service and a detection box set based on a device identifier of the detection device, and send the service identifier and the detection box set to the detection device, wherein the detection box set comprises at least two detection boxes, and different detection boxes correspond to different third position data; and
in response to a second detection request of the detection device for a first detection box, in the case of determining that a display position of the first object in the first detection box matches a preset position, send a detection instruction to the detection device, so that the detection device continues to trigger a third detection request for a second detection box based on the detection instruction until the detection device completes detection of the first object, and acquire the first detection request for the first object.

20. A computer-readable storage medium having stored thereon computer-executable instructions or a computer program that when executed by a processor, implement or implements an object detection method, the object detection method comprising:
determining, in response to a first detection request for a first object, first position data of a key part of the first object at each moment and second position data of a detection device at each moment while the detection device detects the first object;
determining first action data of the first object at each moment based on the first position data, and determining second action data of the detection device at each moment based on the second position data; and
determining a similarity between the first action data and the second action data at a same moment, and determining a detection result for the first object based on the similarity.
